(19) United States
(12) Patent Application Publication
(10) Pub. No.: US 2008/0013424 A1
(43) Pub. Date: Jan. 17, 2008

(54) METHOD FOR RECORDING DATA IN OPTICAL DISC

(75) Inventors: Kang Uk CHO, Suwon-si (KR); Tasaka Shuichi, Suwon-si (KR); Yamasaki Yukihiro, Suwon-si (KR); Yong Jin Ahn, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/754,657

(22) Filed: May 29, 2007

(30) Foreign Application Priority Data
Jul. 14, 2006 (KR) 2006-66492

(51) Int. Cl. G11B 5/00; G11B 7/0045

(52) U.S. Cl. 369/47.53; 369/47.5

(57) ABSTRACT

A method of recording data on an optical disc including a preceding recording layer and a following recording layer capable of having data recorded thereon. The method includes recording data on the preceding recording layer, assigning a weight, to which a difference in recording sensitivities of the preceding and following recording layers of the optical disc is applied, to an OPC (Optimum Power Calibration or Optimum Power Control) recording power of the following recording layer, and determining a starting recording power of the following recording layer, such that data is recorded in the following recording layer, and applying a laser beam having a specific power equal to the starting recording power of the following recording layer to the following recording layer, and recording data on the following recording layer.

### CROSS-REFERENCE TO RELATED APPLICATION

This application claims the benefit of Korean Patent Application No. 2006-66492, filed Jul. 14, 2006 in the Korean Intellectual Property Office, the disclosure of which is incorporated herein by reference.

### BACKGROUND OF THE INVENTION

1. Field of the Invention

Aspects of the present invention relate to an optical disc drive and a method of recording data in the optical disc drive, and, more particularly, to a method of controlling a data recording power when data is recorded in a recordable optical disc (also called a writable optical disc).

2. Description of the Related Art

Generally, a variety of optical discs capable of recording data at least once have been widely used throughout the world. These include, for example, CD-Rs, CD-RWs, DVD±Rs, DVD±RWs, DVD-RAMs, HD-DVDs (High Definition-DVDs), and BDs (Blu-ray Discs), etc. In particular, the R-type discs serve as write-once optical discs, and the RW-type discs or RAM-type discs are capable of re-writing data at least twice (e.g., about several thousand times, or several hundreds of thousands of times).

If the optical disc drive records data in the recordable optical disc, the optical disc drive generates a laser beam via a laser diode, and focuses the laser beam on a data recording layer of the optical disc, such that the laser beam forms a plurality of pits configured to have a specific size, number, and array corresponding to contents of the data. In detail, organic dyes (or organic pigments) are deposited on a recording layer of CD-R or DVD±R. The organic dyes are dissolved by the heat of the laser to form the pits, such that data may be recorded in the recording layer of CD-R or DVD±R. In addition, a phase change alloy, which is changed to a crystalline or amorphous layer according to a temperature, is then deposited on the recording layer of CD-RW, DVD±R, or DVD-RAM. A mark is formed by phase variation of the phase change alloy, such that desired data is recorded in the recording layer.

In order to form a desired-sized pit or mark when data is recorded on an optical disc capable of having data recorded therein, laser power (i.e., recording power) that is required for the data recording must be optimized. Write Strategy technology and OPC (Optimum Power Calibration or Optimum Power Control) technology have been used to optimize the recording power.

In order to optimize data recording and/or reproducing qualities when recording data on the recording medium, different recording strategies may be used depending upon which manufacturing companies manufactured the recording medium or on a category of the recording medium. The manufacturing companies configure a database (DB) of signal characteristics for each recording power of their recording media, and provide the DB to a manufacturing company of an optical disc drive, such that the DB may be referred to during designing/manufacturing processes of the optical disc drive. In this way, the recording strategies corresponding to the manufacturing companies and categories of the recording mediums are prepared during the process for designing/manufacturing the optical disc drive, and are stored in firmware of the optical disc drive.

When recording data on the writable optical disc, the optical disc drive reads identification (ID) information of the loaded optical disc, recognizes a manufacturing company and category of the optical disc, selects a recording strategy corresponding to the recognized manufacturing company and category information of the optical disc, and records data in the recording strategy. A default recording strategy corresponds to categories of the recording medium on a one-to-one basis.

In the meantime, the OPC is indicative of a specific process to determine an optimum recording power. The OPC records test data in a PCA (Power Calibration Area) while changing the recording power in various stages, reproduces the test data, selects a specific recording power having the best modulation coefficient (e.g., the β value) of the reproduced signal (i.e., a playback signal), and determines the selected recording power to be an optimum power calibration (OPC) recording power.

In order to perform the OPC, the optical disc drive moves the optical pickup unit to the PCA, which acts as a test area, changes the recording power based on a predetermined power corresponding to a corresponding optical disc, and at the same time records test data in the PCA. If the recording of the test data is completed, the optical disc drive reproduces the recorded test data, and determines an optimum recording power bases on playback characteristics of the reproduced test data.

The optimum recording power determined by the above-mentioned OPC process in the PCA is indicative of an OPC recording power that is obtained by the execution of the OPC process in the PCA. Therefore, it is considered that the OPC recording power is not always matched with the optimum recording power conditions required to record data in an actual data recording area instead of the PCA. Although data has been recorded in the optical disc at laser power corresponding to the above-mentioned OPC recording power, it may be difficult for a user to have confidence that the optimum recording quality was assigned to the recorded data, resulting in deterioration of reliability of the data recording quality.

### SUMMARY OF THE INVENTION

Therefore, it is an aspect of the invention to provide a method of recording data in an optical disc including a preceding recording layer and a following recording layer, which assigns a weight in which a difference in recording sensitivity of the optical disc is reflected, to a data recording process, determines a starting recording power of the following recording layer, and records data at a laser power corresponding to the starting recording power, resulting in the implementation of more reliable recording quality.

In accordance with an aspect of the invention, the above and/or other aspects may be achieved by the provision of a method of recording data on an optical disc including a preceding recording layer and a following recording layer capable of having data recorded thereon, the method comprising: recording data on the preceding record layer; assigning a weight, to which a difference in recording sensitivities of the preceding and following recording layers of the optical disc is applied, to an OPC (Optimum Power Calibration or Optimum Power Control) recording power of the following recording layer, and determining a starting recording power of the following record layer, such that data is recorded in the following recording layer; and applying a laser beam having a specific power equal to the starting recording power of the following recording layer to the following record layer, and recording data on the following record layer.

According to an embodiment of the invention, the method further comprises: performing an OPC (optimum power calibration) process in a power calibration area of the optical disc prior to the recording of the data in the preceding recording layer, and determining an OPC recording power of the preceding recording layer and the OPC recording power of the following recording layer.

According to an embodiment of the invention, the determining of the starting record power of the following recording layer comprises: calculating a variation between the OPC recording power of the preceding recording layer and an ending record power of the preceding recording layer as a specific value associated with the following recording layer; calculating a weight on the basis of the specific value; and applying the calculated weight to the OPC recording power of the following recording layer.

According to an embodiment of the present invention, the starting recording power of the following recording layer is represented by

$$P {1}^{′} = P 1 \times ( 1 + \frac{( P {0}^{′} - P 0 )}{P 0} ) ,$$

wherein P0 is the OPC recording power of the preceding recording layer, P1 is the OPC recording power of the following recording layer, and P0′ is an ending recording power of the preceding recording layer.

According to an embodiment of the present invention, the determining of the starting recording power of the following recording layer comprises: calculating a variation between the OPC recording power of the preceding recording layer and an ending recording power of the preceding recording layer as a specific value associated with the following recording layer; acquiring the difference in recording sensitivities of the preceding and following recording layers; applying the calculated variation and the acquired difference to the weight; and assigning the weight to the OPC recording power of the following recording layer.

According to an embodiment of the invention, the starting recording power of the following record layer is represented by

$$P {1}^{′} = P 1 \times ( 1 + \frac{( P {0}^{′} - P 0 )}{P 0} \times A ) ,$$

wherein P0 is the OPC recording power of the preceding recording layer, P1 is the OPC recording power of the following recording layer, P0′ is an ending recording power of the preceding recording layer, and A is the difference in recording sensitivities of the preceding and following recording layers.

According to the present invention, the difference in recording sensitivities of the preceding and following recording layers is indicative of a difference between the OPC recording power of the preceding recording layer and the OPC recording power of the following recording layer.

According to an embodiment of the present invention, the difference in the recording sensitivities of the preceding and following recording layers is indicative of a difference between the ending recording power of the preceding recording layer and the OPC recording power of the following recording layer.

According to an embodiment of the present invention, the determining of the starting recording power of the following recording layer comprises: calculating the weight, in which a difference in recording sensitivities of inner and outer areas of the preceding recording layer is reflected, to the OPC recording power of the following recording layer.

According to an embodiment of the present invention, the difference in recording sensitivities of the inner and outer areas of the preceding recording layer is indicative of a difference between a recording-layer thickness of the inner area of the preceding recording layer and a recording-layer thickness of the outer area of the preceding recording layer.

According to an embodiment of the present invention, the record layer comprises any one of an organic dye layer and phase change alloy capable of forming the recording layers of the optical disc capable of recording data therein.

According to an embodiment of the present invention, the starting recording power of the following recording layer is represented by P1=P1+B, wherein P1 is the OPC recording power of the following recording layer, and B is a difference in recording sensitivities of inner and outer areas of the preceding recording layer.

According to an embodiment of the present invention, the applying of the laser beam having the specific power equal to the starting record power of the following recording layer to the following recording layer comprises: continuously updating the starting recording power of the following recording layer to an optimum recording power in which a variation of the recording sensitivity of the following recording layer is considered during the data recording of the following recording layer.

In accordance with another aspect of the present invention, there is provided a method of recording data in an optical disc including a plurality of recording layers capable of having data recording thereon, the method comprising: performing an OPC (optimum power calibration) process in a power calibration area of the optical disc, and determining an OPC recording power of a preceding recording layer and an OPC record power of a following recording layer; recording data in the preceding record layer calculating a variation between the OPC recording power of the preceding recording layer and an ending recording power of the preceding recording layer as a specific value associated with the following recording layer, calculating a weight on the basis of the specific value, applying the calculated weight to the OPC recording power of the following recording layer, and determining a starting recording power of the following record layer, such that data is recorded in the following record layer; and applying a laser beam having a specific power equal to the starting recording power of the following recording layer to the following recording layer, and recording data in the following recording layer.

According to an embodiment of the present invention, the starting recording power of the following recording layer is represented by

$$P {1}^{′} = P 1 \times ( 1 + \frac{( P {0}^{′} - P 0 )}{P 0} ) ,$$

wherein P0 is the OPC recording power of the preceding recording layer, P1 is the OPC recording power of the following recording layer, and P0′ is an ending recording power of the preceding recording layer.

According to an embodiment of the present invention, the applying of the laser beam having the specific power equal to the starting recording power of the following recording layer to the following recording layer comprises: continuously updating the starting recording power of the following recording layer to an optimum recording power in which a variation of the recording sensitivity of the following recording layer is considered during the data recording of the following recording layer.

In accordance with yet another aspect of the present invention, there is provided a method of recording data in an optical disc including a plurality of record layers capable of having data recorded thereon, the method comprising: performing an OPC (optimum power calibration) process in a power calibration area of the optical disc, and determining an OPC recording power of a preceding recording layer and an OPC recording power of a following recording layer; recording data in the preceding recording layer; calculating a variation between the OPC recording power of the preceding recording layer and an ending recording power of the preceding record layer as a specific value associated with the following recording layer, acquiring a difference in recording sensitivity of the preceding and following recording layers, applying the calculated variation and the acquired difference to a weight, assigning the weight to the OPC recording power of the following recording layer, and determining a starting recording power of the following recording layer, such that data is recorded in the following recording layer; and applying a laser beam having a specific power equal to the starting recording power of the following recording layer to the following recording layer, and recording data in the following recording layer.

According to an aspect of the present invention, the starting recording power of the following recording layer is represented by

$$P {1}^{′} = P 1 \times ( 1 + \frac{( P {0}^{′} - P 0 )}{P 0} \times A ) ,$$

wherein P0 is the OPC recording power of the preceding recording layer, P1 is the OPC recording power of the following recording layer, P0′ is an ending recording power of the preceding recording layer, and A is the difference in recording sensitivities of the preceding and following recording layers.

According to an embodiment of the present invention, the difference in recording sensitivity of the preceding and following recording layers is indicative of a difference between the OPC recording power of the preceding recording layer and the OPC recording power of the following recording layer.

According to an embodiment of the present invention, the difference in recording sensitivities of the preceding and following recording layers is indicative of a difference between the ending recording power of the preceding recording layer and the OPC recording power of the following recording layer.

According to an embodiment of the present invention, the applying of the laser beam having the specific power equal to the starting recording power of the following recording layer to the following recording layer comprises: continuously updating the starting recording power of the following recording layer to an optimum recording power in which a variation of the recording sensitivity of the following recording layer is considered during the data recording of the following recording layer.

In accordance with yet another aspect of the present invention, there is provided a method of recording data in an optical disc including a plurality of record layers capable of recording data therein, the method comprising: performing an OPC (optimum power calibration) process in a power calibration area of the optical disc, and determining an OPC record power of a preceding recording layer and an OPC recording power of a following recording layer; recording data in the preceding record layer; calculating a weight, in which a difference in recording sensitivity of inner and outer areas of the preceding recording layer is reflected, to the OPC recording power of the following recording layer, and determining a starting recording power of the following recording layer, such that data is recorded in the following recording layer; and applying a laser beam having a specific power equal to the starting record power of the following recording layer to the following recording layer, and recording data in the following recording layer.

According to an embodiment of the present invention, the difference in recording sensitivities of the inner and outer areas of the preceding recording layer is indicative of a difference between a recording-layer thickness of the inner area of the preceding recording layer and a recording-layer thickness of the outer area of the preceding recording layer.

According to an aspect of the present invention, the recording layer comprises any one of an organic dye layer and phase change alloy capable of forming the recording layers of the optical disc capable of recording data therein.

According to an aspect of the present invention, the starting recording power of the following recording layer is represented by P1=P1+B, wherein P1 is the OPC recording power of the following recording layer, and B is a difference in recording sensitivities of inner and outer areas of the preceding recording layer.

According to an aspect of the present invention, the applying of the laser beam having the specific power equal to the starting record power of the following record layer to the following record layer comprises: continuously updating the starting recording power of the following recording layer to an optimum recording power in which a variation of the recording sensitivity of the following recording layer is considered during the data recording of the following recording layer.

In accordance with yet another aspect of this invention, a method of recording data onto first and second recording areas of an optical disc, comprises: determining a first optimum recording power at which data is to be written onto the first recording area; recording data on the first recording area at the first optimum recording power; determining a difference between recording sensitivities of the first and second recording areas; determining a second optimum recording power by adjusting the first optimum recording power according to the difference in the recording sensitivities of the first and second recording areas; and recording data on the second recording area at the second optimum recording power.

According to this aspect of the invention, the first and second recording areas of the optical disc are located on first and second recording layers of the optical disc, respectively.

According to this aspect of the invention, the method further comprises recalibrating the first optimum recording power during the recording of the data on the first recording area, and recording data on a remaining section of the first recording area at the recalibrated first optimum recording power.

According to this aspect of the invention, the adjusting of the first optimum recording power comprises determining a current level of the first optimum recording power following the recalibration of the first optimum recording power.

According to this aspect of the invention, the method further comprises recalibrating the second optimum recording power during the recording of the data on the second recording area, and recording data on a remaining section of the second recording area at the recalibrated second optimum recording power.

According to this aspect of the invention, a jitter and an asymmetry of a signal generated from the recording of the data is approximately 15.7% and 1.4%, respectively.

In accordance with another aspect of the invention, a controller of an optical disc drive, including a laser diode to emit a laser beam toward an optical disc so as to record and/or reproduce information onto and/or from the optical disc, determines a first optimum recording power at which the information is to be written onto a first recording area of the optical disc, records data onto the first recording area at the first optimum recording power, to determine a difference between a recording sensitivity the first recording area and a recording sensitivity of a second recording area, determines a second optimum recording power by adjusting the first optimum recording power according to the difference in the recording sensitivities of the first and second recording areas, and records data on the second recording area at the second optimum recording power.

Additional and/or other aspects and advantages of the invention will be set forth in part in the description which follows and, in part, will be obvious from the description, or may be learned by practice of the invention

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a structural diagram illustrating the appearance of a recordable or writable optical disc according to an embodiment of the present invention;

FIG. 2 is a cross-sectional view illustrating the recordable or writable optical disc shown in FIG. 1;

FIG. 3 shows record powers required for recording data in the optical disc shown in FIG. 2;

FIG. 4 is a block diagram illustrating an optical disc drive according to an embodiment of the present invention; and

FIG. 5A and FIG. 5B are flow charts illustrating a method of recording data in an optical disc according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

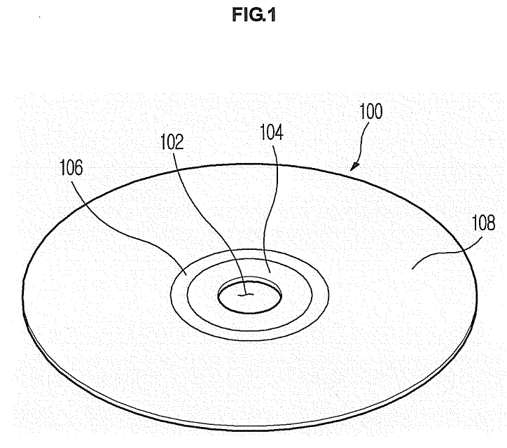

FIG. 1 is a structural diagram illustrating an appearance of a recordable or writable optical disc according to an embodiment of the present invention. As shown in FIG. 1, a clamping hole 12 is located at the center part of an optical disc 100 (hereinafter referred to as a multi-layer optical disc) including a plurality of recording layers capable of having data recorded thereon. A clamping hole 102 is defined at a central region of the optical disc 100 through which a rotation axle is inserted when the optical disc 100 is seated in an optical disc drive to rotate the optical disc 100. A clamping unit 104 allows the optical disc 100 to be fixed while rotating in the optical disc drive and is arranged at a peripheral area of the clamping hole 102. A Power Calibration Area (PCA) 106 is arranged outside of the clamping area 104 and an information area 108 is arranged outside of the PCA 106.

The PCA 106 is a test area that allows for an optimizing of the recording power of a laser beam focused on a data recording surface of the optical disc 100. The higher the number of power calibrations, the smaller the size of the PCA 106. Information indicating the number of power calibrations is recorded as count data. If the optical disc is seated in the optical disc 100 to have data recorded thereon, and a user enters a recording command, the optical disc drive first performs the OPC, and determines the optimum recording power. The OPC determines the optimum laser power with consideration given to variations in peripheral environments (e.g., record speed, temperature, and humidity) and a variation (or a difference) in physical characteristics of the optical disc 100.

The information area 108 acts as a specific area in which data to be recorded is actually recorded. If data is recorded in the information area 108, at least one Lead-In area, at least data area, and at least one Lead-Out area are sequentially arranged in the information area 108. If a recording apparatus capable of performing a multi-session process and an optical disc for the multi-session are used, the information area 108 includes a predetermined number of groups, each of which includes “Lead-In area→Data Area→Lead-out area”, proportional to the number of multi-session times.

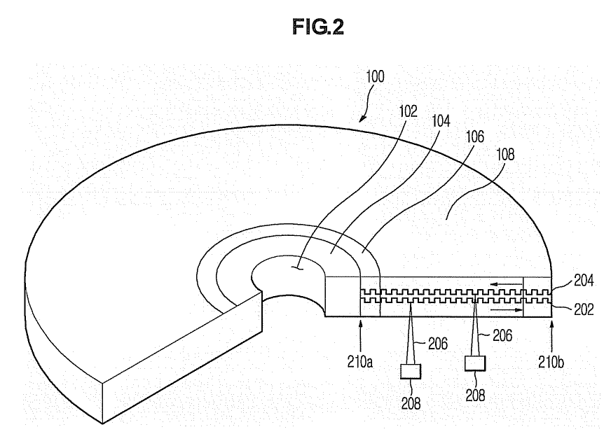

FIG. 2 is a cross-sectional view illustrating the recordable or writable optical disc shown in FIG. 1. As shown in FIG. 2, the optical disc 100 includes two recording layers 202 and 204, each of which may have data recorded thereon. Where the optical disc comprises the two recording layers (i.e., a dual-layer optical disc) 202 and 204, the lower recording layer 202 is represented by the term, “recording layer 0” (Layer 0), and the upper recording layer 204 is represented by the term, “recording layer 1” (Layer 1).

With reference to the structure of the optical disc 100 shown in FIG. 2, data is first recorded in the lower recording layer 202 until the recording capacity of the lower recording layer 202 is reached. Data is then recorded in the upper recording layer 204. For the convenience of description and a better understanding of aspects of the present invention, it is assumed that the lower recording layer 202 of FIG. 2 is referred to as a preceding recording layer, and the upper recording layer 204 of FIG. 2 is referred to as a following recording layer.

Each of the preceding recording layer 202 and the following recording layer includes successive spiral tracks, each of which may have data recorded thereon. A pickup module 208 to record the data in each recording layer 202 or 204 moves from an inner area 210a to the outer area 210b of the optical disc 100, or moves from the outer area 210b to the inner area 210a, and at the same time applies a laser beam 206 to a track of a corresponding recording layer. The data recording process in the preceding recording layer 202 or the following recording layer 204 is performed according to an OTP (Opposite Track Path) scheme. When recording and/or reproducing data on and/or from the optical disc, including two or more recording layers, the OTP scheme provides that moving directions of the pickup module is opposite to each other.

According to the OTP scheme, the pickup module 208 moves from the inner area 210a of the optical disc 100 to the outer area 210b when data is recorded on the preceding recording layer 202, and from the outer area 210b to the inner area 210a when data is recorded on the following recording layer 204.

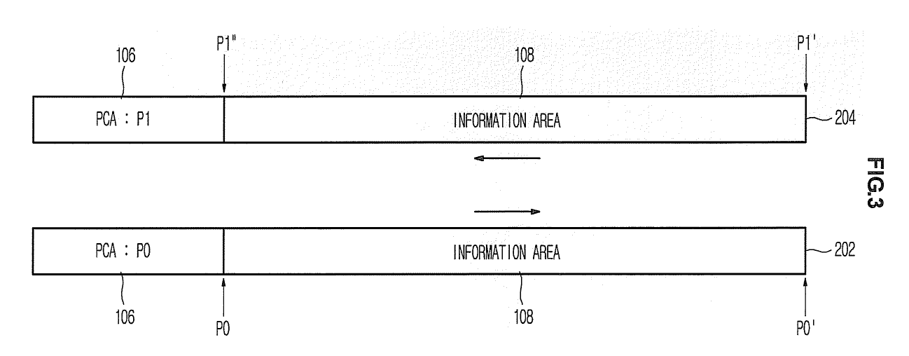

FIG. 3 shows recording powers required to record data on the optical disc shown in FIG. 2 according to the present invention. The OPC is performed in the PCA 106 located at the inner area 210a of the optical disc 100 prior to the starting of the recording of the data. The OPC process is separately performed in each recording layer 202 or 204. In this way, if the above-mentioned OPC is separately performed in the recording layers 202 and 204, a first OPC recording power P0 of the preceding recording layer 202 and a second OPC recording power P1 of the following recording layer 204 are determined, respectively.

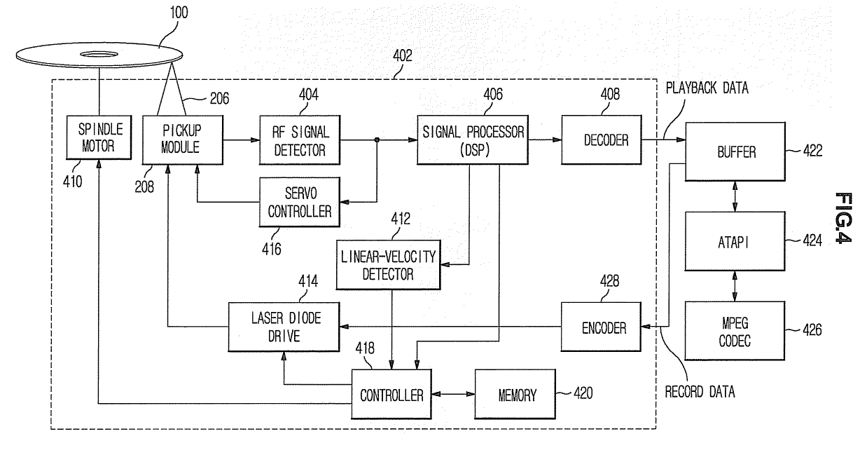

During the data recording process, the first OPC recording power P0 of the preceding recording layer 202 is employed at the starting time of the data recording at the preceding recording layer 202, such that the laser power is controlled at the first OPC recording power P0. However, during the data recording process at the preceding recording layer 202, the value of the recording power is continuously updated to maintain an optimum laser power in consideration of a difference in physical characteristics of the optical disc 100 and the optical disc drive (See FIG. 4). The ending recording power P0′ of the preceding recording layer 202 is indicative of a specific recording power that is optimized at the ending time of the data recording at the preceding recording layer 202.

In accordance with an embodiment of the present invention, when the recording of the data on the following recording layer 204 begins after the recording of the data in the preceding recording layer 202, a new starting recording power P1′ of the following recording layer 204 is determined. In other words, the starting recording power P1′ of the following recording layer 204 is determined in consideration of physical characteristics of the optical disc 100 that are acquired before the recording of the data in the following recording layer 204. To this end, a laser beam having a specific power corresponding to the starting recording power P1′ of the following recording layer 204 is applied to a data recording surface of the following recording layer 204, such that the recording of the data on the following recording layer 204 may begin. If the data recording of the following recording layer 204 begins at the starting recording power P1′ of the following recording layer 204, the recording of the data on the following recording layer 204 may begin at a more-optimized starting recording power P1′. Further, the starting recording power P1′ will take into account the actual physical characteristics of the optical disc 100 (as opposed to the recording power P1 of the following recording layer that is acquired during the OPC process prior to the starting of the recording of the data).

While recording data in the following recording layer 204, the value of the recording power is continuously updated so as to maintain the optimum laser power in consideration of a variation in physical characteristics of the optical disc 100 as well as a variation in peripheral environments of the optical disc drive 402. The reference symbol P1” of FIG. 3 is indicative of the ending recording power of the following recording layer 204.

In accordance with an embodiment of the present invention, a predetermined weight is assigned to the OPC recording power P1 of the following recording layer 204, such that the starting recording power P1′ of the following recording layer 204 is determined. When recording data in the preceding recording layer 202, actual physical characteristics information of the preceding recording layer 202 or a difference (or variation) of the aforementioned actual physical characteristics (or recording sensitivity) is acquired, such that the actual physical characteristics information of the preceding recording layer 202 or a variation thereof is reflected in the data recording process of the preceding recording layer 202.

A method of determining the starting recording power P1′ of the following recording layer 204 according to an embodiment of the present invention may be represented by the following equations 1, 2, and 3. When determining the starting recording power P1′ of the following recording layer 204, any one of the three equations 1˜3 or a combination of at least two of the three equations may be employed. Needless to say, other methods that are capable of determining the starting recording power P1′ of the following recording layer 204 with consideration given to physical characteristics of the optical disc 100 that are acquired prior to the recording of data onto the following recording layer 204 or a variation of the physical characteristics of the optical disc 100 may also be used even if these methods do not include the use of any of the three equations.

$$P {1}^{′} = P 1 \times ( 1 + \frac{P {0}^{′} - P 0}{P 0} ) \qquad [ Equation 1 ]$$

The method of determining the starting recording power P1′ of the following recording layer 204 is represented by the above-mentioned Equation 1. A variation between the starting recording power of the preceding recording layer 202 (i.e., OPC recording power P0) and the ending recording power P0′ is calculated as a specific value that is associated with the following recording layer 204, such that the specific value denoted by

$$P 1 \times ( \frac{P {0}^{′} - P 0}{P 0} )$$

is acquired. A weight is applied to the value

$$P 1 \times ( \frac{( P {0}^{′} - P 0 )}{P 0} ) ,$$

such that the resultant weight is assigned to the OPC recording powering P1 of the following recording layer 204.

While recording data in the preceding recording layer 202 of the optical disc 100, the recording sensitivity of the preceding recording layer 202 is continuously changed according to a variation in temperature of a laser diode or a variation in physical characteristics (e.g., a tilt), and the recording power of the preceding recording layer 202 is also continuously changed in a specific direction to compensate for the variation of the recording sensitivity simultaneously with the acquiring of the optimum recording sensitivity. Therefore, the process of determining the starting recording power P1′ of the following recording layer 204 does not depend on the OPC result (i.e., OPC recording powers P0 and P1) of the PCA 106, and assigns a weight to the OPC recording power P1 with consideration given to the ending recording power P0′ of the preceding recording layer 202, in which the variation of actual recording sensitivity of the preceding recording layer 202 is reflected, such that a more-optimized starting recording power P1′ of the following recording layer 204 may be determined as denoted by the following Equation 2:

$$P {1}^{′} = P 1 \times ( 1 + \frac{P {0}^{′} - P 0}{P 0} \times A ) . \qquad [ Equation 2 ]$$

The method of determining the starting recording power P1′ of the following recording layer 204 is represented by Equation 2. The determination method of Equation 2 additionally calculates a difference A in recording sensitivities of the preceding and following recording layers 202 and 204, respectively, and applies the difference A to the Equation 1. In more detail, a variation between the OPC recording power P0 and the ending recording power P0′ of the preceding recording layer 202 is calculated as a specific value associated with the following recording layer 204, and a difference between the recording sensitivity of the preceding recording layer 202 and the recording sensitivity of the following recording layer 204 is acquired, such that a weight may be applied to the calculated specific value and the difference between recording sensitivities of the preceding recording layer 202 and the following recording layer 204. The resultant weight is assigned to the OPC recording power P1 of the following recording layer 204. When recording data at the same laser power, if the recording sensitivity of the preceding recording layer 202 is different from that of the following recording layer 204, the size of each pit formed in the preceding recording layer 202 may be different from that of each pit formed in the following recording layer 204, such that the starting recording power P1′ of the following recording layer 204 is determined in a specific direction in which the difference between the recording sensitivity of the preceding recording layer 202 and the recording sensitivity of the following recording layer 204 is corrected.

With reference to Equation 2, the reference character “A” is indicative of the difference between the recording sensitivity of the preceding recording layer 202 and the recording sensitivity of the following recording layer 204. For example, the reference character “A” may be indicative of a difference (i.e., A=P0−P1) between the OPC recording power P0 of the preceding recording layer 202 and the OPC recording power P1 of the following recording layer 204, or may be indicative of a difference (i.e., A=P0′−P1) between the ending recording power P0′ of the preceding recording layer 202 and the OPC recording power P1 of the following recording layer 204. As another example, the reference character “A” may also use another value that is capable of representing the difference between the recording sensitivity of the preceding recording layer 202 and the recording sensitivity of the following recording layer 204.

P1′=P1+B [Equation 3]

The method of determining the starting recording power P1′ of the following recording layer 204 is represented by the above-mentioned Equation 3. As shown, the determination method calculates a difference B in other recording sensitivities of the preceding and following recording layers 202 and 204, and reflects the difference B in the OPC recording power P1 of the following recording layer 204. The difference B in the recording sensitivity of the preceding and following recording layers 202 and 204 is caused by a difference in thicknesses of recording layers formed on data recording surfaces. The above-mentioned thickness difference is indicative of a difference between a recording layer thickness of the inner area and a recording layer thickness of the outer area. In the case of CD-R or DVD±R, the above-mentioned recording layer corresponds to an organic dye layer. In the case of CD-RW, DVD±RW, or DVD-RAM, the above-mentioned recording layer corresponds to a phase change alloy.

However, a specific time to determine the starting recording power P1′ of the following recording layer 204 is provided before data is recorded in the following recording layer 204, such that recognizing a difference in thickness of the inner and outer areas of the following recording layer 204 may be impossible or unlikely. Therefore, the above-mentioned recording-sensitivity difference caused by the recording-layer thickness of the inner and outer areas of the preceding recording layer 202 is used to determine the starting recording power P1′ of the following recording layer 204.

FIG. 4 is a block diagram to illustrate an optical disc drive 402 according to the present invention. As shown in FIG. 4, the disc drive includes a buffer 422, Advanced Technology Attachment Packet Interface (ATAPI) 424, and a Motion Pictures Experts Group compression/decompression (MPEG CODEC) 426. If required, the buffer 422, the ATAPI interface 424, and the MPEG CODEC 426 may also be contained in the optical disc drive 402. The ATAPI is a representative data communication interface between the optical disc drive and a CODEC chip. The optical disc 100 rotates under the control of a spindle motor 410. The spindle motor 410 is controlled by a drive signal generated from the controller 418.

The pickup module 208 includes a laser diode, and applies a laser beam having a specific recording power to a recording surface of the optical disc 100 via the laser diode, such that data is recorded in the optical disc 100. The laser beam, having a specific power equal to a recording power is applied to the optical disc 100, such that the data recorded in the optical disc 100 may thereafter be reproduced or read.

When recording data in the optical disc 100, the recorded data is encoded by the encoder 428, and is then applied to the laser diode drive 414. The controller 418 transmits a drive signal to record the encoded data on the data recording surface of the optical disc 100 to the laser diode drive 141, such that the recording power of the laser diode is changed. Indeed, a control operation of the recording power based on the OPC is achieved by a control signal applied to the laser diode 414.

When reproducing data from the optical disc 100, the laser beam having a specific power equal to a playback power is generated from the laser diode of the pickup module 208, and is then applied to the data recording surface of the optical disc 100. If the laser beam is reflected from the data recording surface of the optical disc 100, the RF signal detector 404 receives the reflected laser beam, amplifies the RF signal, and converts the amplified RF signal into a binary signal. The binary signal received from the RF signal detector 404 is restored to digital data by the signal processor (DSP) 406. The restored digital data is encoded, such that the decoder 408 decodes the encoded digital data to digital data created prior to the encoding.

The signal processor (DSP) 406 calculates a variety of values (i.e., β, α, a peak value, a bottom value, and an average value, etc.) from the RF signal, and provides the calculated values to the controller 418. The RF signal is then provided to the servo controller 416, which generates a tracking-error signal and a focusing-error signal from the RF signal, and controls the tracking- or focusing-operation of the pickup module 208 by referring to the tracking-error signal and the focusing-error signal, respectively.

The linear-velocity detector 412 detects a linear velocity of the optical disc 100 during the data recording, and provides the controller 418 with the detected linear velocity.

The controller 418 controls overall operations of the optical disc drive 402. The controller 418 includes a memory 420 to store information required to control operations of the optical disc drive 402 or data created in the control process. The controller 418 controls a rotation speed of the optical disc 100 by controlling the spindle motor 410. The controller 418 performs the OPC process by referring to the writing strategy, X-speed (e.g., 2× or 3×-speed), sensitivity of a photo-diode to receive the reflected laser beam, and peak-, bottom-, and average-values of the signal detected by the signal processor 406, such that the controller 418 is able to determine the OPC recording power.

If the starting recording power P1′ of the following recording layer 204 is determined by any one of the Equations 1, 2, and 3, the controller 418 controls the laser-diode drive 414 to generate a laser beam having the determined recording power P1′.

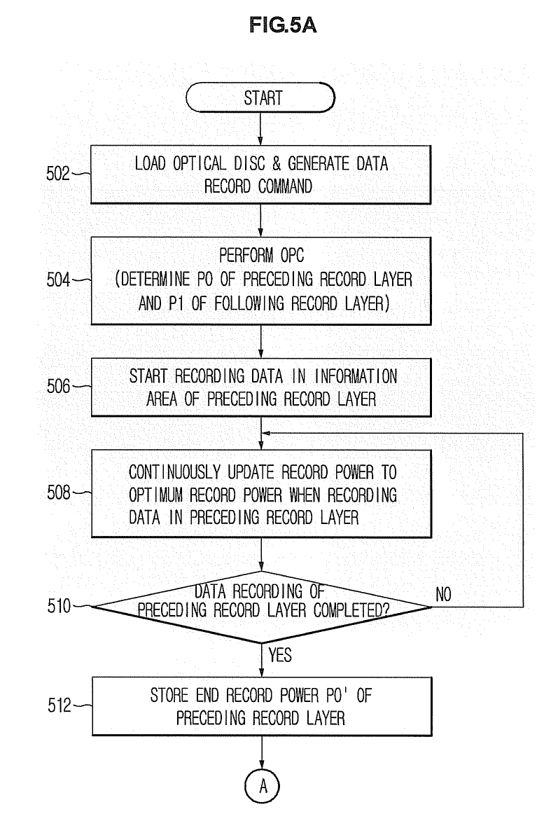

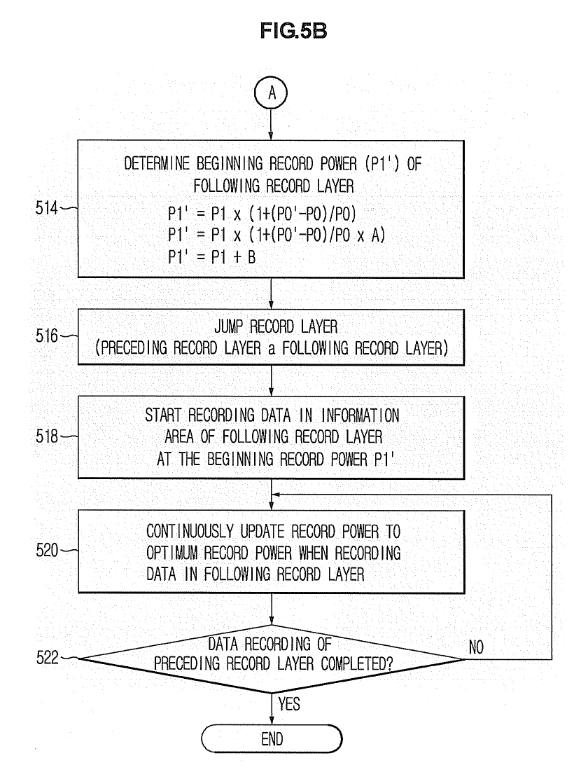

FIGS. 5A-5B are flow charts illustrating a method of recording data in an optical disc according to an embodiment of the present invention. As shown in FIG. 5A, in order to record data in the optical disc 100, the recordable optical disc 100 must be seated in the optical disc drive 402, and a data recording command to record data in the optical disc 100 must occur at operation 502. If the data recording command occurs, the PCA 106 performs the OPC process to determine the OPC recording power P1 of the following recording layer 204 and the OPC recording power P0 of the preceding recording layer 202 at operation 504.

In this way, if the OPC recording power P1 of the following recording layer 204 and the OPC recording power P0 of the preceding recording layer 202 are determined, the OPC recording power P0 of the preceding recording layer 202 is used as the starting recording power, such that data begins to be recorded in the information area 108 of the preceding recording layer 202 at the OPC recording power P0 at operation 506. When recording data in the information area 108 of the preceding recording layer 202, variations in the physical characteristics of the optical disc 100 and peripheral environments of the optical disc drive 402 are considered, and the recording power value is updated to an optimum recording power value to always maintain the optimum laser power, such that data is recorded at the optimum recording power all over the preceding recording layer 202 at operation 508. If the data recording of the preceding recording layer 202 is completed at the optimum recording power at operation 510, the ending recording power P0′ of the preceding recording layer 202 (i.e., the last data recording power of the preceding recording layer 202) is stored in the memory 420 at operation 512.

As shown in FIG. 5B, if the recording of data onto the preceding recording layer 202 is completed, the starting recording power P1′ of the following recording layer 204 is determined to allow for a recording of data in the following recording layer 204 at the optimum recording power at operation 514. The starting recording power P1′ of the following recording layer 204 may be determined by at least one of the Equations 1, 2, and 3. If the starting recording power P1 of the following recording layer 204 is determined, a layer-jump operation from the preceding recording layer 202 to the following recording layer 204 is executed to record data in the following recording layer 204 at operation 516. Data is recorded in the information area 108 of the following recording layer 204 at the starting recording power P1′ of the following recording layer 204 at operation 518. During the recording of the data in the information area 108 of the following recording layer 204, since variations in the physical characteristics of the optical disc 100 and the peripheral environments of the optical disc drive 402 are considered, and since the recording power value is updated to an optimum recording power value, data is recorded at the optimum recording power all over the following recording layer 204 at operation 520. If the data recording of the following recording layer 204 is completed at the optimum recording power at operation 522, the data recording of the optical disc 100 is completed.

The following Table 1 shows recording qualities measured by recording data in the recordable optical disc.

TABLE 1

| | Conventional Art | The present invention |
|---|---|---|
| Recording Power | 20.8 mW | 22.6 mW |
| D—D (Data-to-Data) Jitter | 22.8% | 15.7% |
| Asymmetry | −12.3% | 1.4% |

With reference to Table 1, has aspects of the present invention have data recording qualities (e.g., D-D jitter and asymmetry of RF signal used as a standard to estimate the recording quality) superior to those of the conventional art.

The lower the jitter and the asymmetry of the RF signal, the higher the data recording and/or reproducing qualities of the optical disc. Specifically, an absolute value of an asymmetric characteristic value is adapted to determine the recording and/or reproducing qualities based on the asymmetry, without considering a code of the asymmetric characteristics value. As can be seen from Table 1, the absolute value 12.3% of the conventional asymmetric characteristic value −12.3% is adapted to determine the data recording/reproducing qualities.

As is apparent from the above description, the method of recording data in the optical disc according to aspects of the present invention determine an optimum starting recording power required to record data in the following recording layer of the optical disc including a plurality of recording layers. Data is recorded in the following recording layer at a laser power equal to the optimum starting recording power, and the recording power is continuously updated to new recording power during the data recording of the following recording layer, such that the optimized recording power may be used to record data on the optical disc. As a result, the above-mentioned optimized data recording of the optical disc increases the data recording quality of the optical disc drive, resulting in increased reliability of performance of the optical disc drive.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of recording data on an optical disc including a preceding recording layer and a following recording layer capable of having data recorded thereon, the method comprising:
recording data on the preceding recording layer;
assigning a weight, to which a difference in recording sensitivities of the preceding and following recording layers of the optical disc is applied, to an Optimum Power Calibration (OPC) recording power of the following recording layer, and determining a starting recording power of the following recording layer, such that data is recorded in the following recording layer; and
applying a laser beam having a specific power equal to the starting recording power of the following recording layer to the following recording layer, and recording data on the following recording layer.

2. The method according to claim 1, further comprising:
performing an OPC (optimum power calibration) process in a power calibration area of the optical disc prior to the recording of the data on the preceding recording layer; and
determining an OPC recording power of the preceding recording layer and the OPC recording power of the following recording layer.

3. The method according to claim 1, wherein the determining of the starting recording power of the following recording layer comprises:
calculating a variation between the OPC recording power of the preceding recording layer and an ending recording power of the preceding recording layer as a specific value associated with the following recording layer;
calculating the weight based on the specific value; and
applying the calculated weight to the OPC recording power of the following recording layer.

4. The method according to claim 1, wherein the starting recording power of the following recording layer is represented by
$$P {1}^{′} = P 1 \times ( 1 + \frac{( P {0}^{′} - P 0 )}{P 0} ) ,$$
wherein P0 is the OPC recording power of the preceding recording layer, P1 is the OPC recording power of the following recording layer, and P0′ is an ending recording power of the preceding recording layer.

5. The method according to claim 1, wherein the determining of the starting recording power of the following recording layer comprises:
calculating a variation between the OPC recording power of the preceding recording layer and an ending recording power of the preceding recording layer as a specific value associated with the following recording layer;
acquiring the difference in recording sensitivities of the preceding and following recording layers;
applying the calculated variation and the acquired difference to the weight; and
assigning the weight to the OPC recording power of the following recording layer.

6. The method according to claim 1, wherein the starting recording power of the following recording layer is represented by
$$P {1}^{′} = P 1 \times ( 1 + \frac{( P {0}^{′} - P 0 )}{P 0} \times A ) ,$$
wherein P0 is the OPC recording power of the preceding recording layer, P1 is the OPC recording power of the following recording layer, P0′ is an ending recording power of the preceding recording layer, and A is the difference in the recording sensitivities of the preceding and following recording layers.

7. The method according to claim 6, wherein the difference in the recording sensitivities of the preceding and following recording layers is indicative of a difference between the OPC recording power of the preceding recording layer and the OPC recording power of the following recording layer.

8. The method according to claim 6, wherein the difference in the recording sensitivities of the preceding and following recording layers is indicative of a difference between the ending recording power of the preceding recording layer and the OPC recording power of the following recording layer.

9. The method according to claim 1, wherein the determining of the starting recording power of the following recording layer comprises calculating the weight, in which a difference in recording sensitivities of inner and outer areas of the preceding recording layer is reflected, to the OPC recording power of the following recording layer.

10. The method according to claim 9, wherein the difference in recording sensitivities of the inner and outer areas of the preceding recording layer is indicative of a difference between a recording-layer thickness of the inner area of the preceding recording layer and a recording-layer thickness of the outer area of the preceding recording layer.

11. The method according to claim 10, wherein the recording layer comprises any one of an organic dye layer and phase change alloy that form the recording layers of the optical disc capable of recording data therein.

12. The method according to claim 1, wherein the starting recording power of the following recording layer is represented by P1′=P1+B, wherein P1 is the OPC recording power of the following recording layer, and B is a difference in recording sensitivities of inner and outer areas of the preceding recording layer.

13. The method according to claim 1, wherein the applying of the laser beam comprises continuously updating the starting recording power of the following recording layer to an optimum recording power in which a variation of the recording sensitivity of the following recording layer is considered during the data recording of the following recording layer.

14. A method of recording data in an optical disc including a plurality of recording layers capable of having data recorded thereon, the method comprising:
performing an OPC (optimum power calibration) process in a power calibration area of the optical disc, and determining an OPC recording power of a preceding recording layer and an OPC recording power of a following recording layer;
recording data in the preceding recording layer;
calculating a variation between the OPC recording power of the preceding recording layer and an ending recording power of the preceding recording layer as a specific value associated with the following recording layer, calculating a weight on the basis of the specific value, applying the calculated weight to the OPC recording power of the following recording layer, and determining a starting recording power of the following recording layer, such that data is recorded in the following recording layer; and
applying a laser beam having a specific power equal to the starting recording power of the following recording layer to the following recording layer, and recording data in the following recording layer.

15. The method according to claim 14, wherein the starting recording power of the following recording layer is represented by
$$P {1}^{′} = P 1 \times ( 1 + \frac{( P {0}^{′} - P 0 )}{P 0} ) ,$$
wherein P0 is the OPC recording power of the preceding recording layer, P1 is the OPC recording power of the following recording layer, and P0′ is an ending recording power of the preceding recording layer.

16. The method according to claim 14, wherein the applying of the laser beam comprises continuously updating the starting recording power of the following recording layer to an optimum recording power in which a variation of the recording sensitivity of the following recording layer is considered during the data recording of the following recording layer.

17. A method of recording data in an optical disc including a plurality of recording layers capable of having data recorded thereon, the method comprising:
performing an OPC (optimum power calibration) process in a power calibration area of the optical disc, and determining an OPC recording power of a preceding recording layer and an OPC recording power of a following recording layer;
recording data in the preceding recording layer;
calculating a variation between the OPC recording power of the preceding recording layer and an ending recording power of the preceding recording layer as a specific value associated with the following recording layer, acquiring a difference in recording sensitivity of the preceding and following recording layers, applying the calculated variation and the acquired difference to a weight, assigning the weight to the OPC recording power of the following recording layer, and determining a starting recording power of the following recording layer, such that data is recorded in the following recording layer; and
applying a laser beam having a specific power equal to the starting recording power of the following recording layer to the following recording layer, and recording data in the following recording layer.

18. The method according to claim 17, wherein the starting recording power of the following recording layer is represented by
$$P {1}^{′} = P 1 \times ( 1 + \frac{( P {0}^{′} - P 0 )}{P 0} \times A ) ,$$
wherein P0 is the OPC recording power of the preceding recording layer, P1 is the OPC recording power of the following recording layer, P0′ is an ending recording power of the preceding recording layer, and A is the difference in recording sensitivities of the preceding and following recording layers.

19. The method according to claim 18, wherein the difference in recording sensitivities of the preceding and following recording layers is indicative of a difference between the OPC recording power of the preceding recording layer and the OPC recording power of the following recording layer.

20. The method according to claim 18, wherein the difference in recording sensitivities of the preceding and following recording layers is indicative of a difference between the ending recording power of the preceding recording layer and the OPC recording power of the following recording layer.

21. The method according to claim 17, wherein the applying of the laser beam comprises continuously updating the starting recording power of the following recording layer to an optimum recording power in which a variation of the recording sensitivity of the following recording layer is considered during the data recording of the following recording layer.

22. A method of recording data in an optical disc including a plurality of recording layers capable of recording data therein, the method comprising:
performing an OPC (optimum power calibration) process in a power calibration area of the optical disc, and determining an OPC recording power of a preceding recording layer and an OPC recording power of a following recording layer;
recording data in the preceding recording layer;
calculating a weight, in which a difference in recording sensitivity of inner and outer areas of the preceding recording layer is reflected, to the OPC recording power of the following recording layer, and determining a starting recording power of the following recording layer, such that data is recorded in the following recording layer; and
applying a laser beam having a specific power equal to the starting recording power of the following recording layer to the following recording layer, and recording data in the following recording layer.

23. The method according to claim 22, wherein the difference in recording sensitivities of the inner and outer areas of the preceding recording layer is indicative of a difference between a recording-layer thickness of the inner area of the preceding recording layer and a recording-layer thickness of the outer area of the preceding recording layer.

24. The method according to claim 23, wherein the recording layer comprises any one of an organic dye layer and phase change alloy capable of forming the recording layers of the optical disc capable of recording data therein.

25. The method according to claim 22, wherein the starting recording power of the following recording layer is represented by P1′=P1+B, wherein P1 is the OPC recording power of the following recording layer, and B is a difference in recording sensitivities of inner and outer areas of the preceding recording layer.

26. The method according to claim 22, wherein the applying of the laser beam comprises continuously updating the starting recording power of the following recording layer to an optimum recording power in which a variation of the recording sensitivity of the following recording layer is considered during the data recording of the following recording layer.

27. A method of recording data onto first and second recording areas of an optical disc, the method comprising:
determining a first optimum recording power at which data is to be written onto the first recording area;
recording data on the first recording area at the first optimum recording power;
determining a difference between recording sensitivities of the first and second recording areas;
determining a second optimum recording power by adjusting the first optimum recording power according to the difference in the recording sensitivities of the first and second recording areas; and
recording data on the second recording area at the second optimum recording power.

28. The method according to claim 27, wherein the first and second recording areas of the optical disc are located on first and second recording layers of the optical disc, respectively.

29. The method according to claim 27, further comprising:
recalibrating the first optimum recording power during the recording of the data on the first recording area; and
recording data on a remaining section of the first recording area at the recalibrated first optimum recording power.

30. The method according to claim 29, wherein the adjusting of the first optimum recording power comprises determining a current level of the first optimum recording power following the recalibration of the first optimum recording power.

31. The method according to claim 27, further comprising:
recalibrating the second optimum recording power during the recording of the data on the second recording area; and
recording data on a remaining section of the second recording area at the recalibrated second optimum recording power.

32. The method according to claim 27, wherein a jitter and an asymmetry of a signal generated from the recording of the data is approximately 15.7% and 1.4%, respectively.

33. A controller of an optical disc drive, including a laser diode to emit a laser beam toward an optical disc so as to record and/or reproduce information onto and/or from the optical disc, to determine a first optimum recording power at which the information is to be written onto a first recording area of the optical disc, to record data onto the first recording area at the first optimum recording power, to determine a difference between a recording sensitivity the first recording area and a recording sensitivity of a second recording area, to determine a second optimum recording power by adjusting the first optimum recording power according to the difference in the recording sensitivities of the first and second recording areas, and to record data on the second recording area at the second optimum recording power.
